(19) United States
(12) Patent Application Publication
(10) Pub. No.: US 2026/0140304 A1
(43) Pub. Date: May 21, 2026

(54) VERTICALLY INTEGRATED OPTICAL TRANSCEIVERS FOR WAVELENGTH DIVISION MULTIPLEXING

(71) Applicant: NVIDIA Corporation, Santa Clara, CA (US)

(72) Inventors: Hao Li, Vancouver, WA (US); Mir Ashkan Seyedi, Atlanta, GA (US); Meer Sakib, Berkeley, CA (US); Olakanmi Oluwole, Mountain View, CA (US); Vishnu Balan, Saratoga, CA (US); Ming-Ju E. Lee, Saratoga, CA (US)

(21) Appl. No.: 18/954,356

(22) Filed: Nov. 20, 2024

(51) Int. Cl. G02B 6/12; G02B 6/26; H04J 14/02

(52) U.S. Cl. CPC G02B 6/12004; G02B 6/26; H04J 14/0205

(57) ABSTRACT

Disclosed are systems, and techniques for vertical integration of wavelength-division multiplexing devices for improved efficiency of fiber-optic communications. In one embodiment, a disclosed optical connector includes a photonic integrated circuit that has a plurality of optical interconnects configured to support propagation of a plurality of spectral beams, and a plurality of optical couplers, configured to direct the spectral beams away from a plane of the photonic integrated circuit. The optical connector further includes a spectral multiplexer having a plurality of optical elements configured to iteratively combine the plurality of spectral beams into a combined beam, and an optical fiber interface configured to direct the combined beam to an optical fiber external to the optical connector.

### TECHNICAL FIELD

At least one embodiment pertains to systems and techniques deployed to facilitate data communications using optical fibers. For example, at least one embodiment pertains to optical transceivers that support efficient wavelength division multiplexing for fiber-optic communications.

### BACKGROUND

In fiber-optic communications, data is carried between a transmitting device and a receiving device by electromagnetic (e.g., infrared, visible, etc.) waves that are modulated, e.g., with electrical radio frequency (RF) signals. Compared with electrical communication cables, fiber-optic cables allow higher ranges, bandwidths, and throughputs of transmission and are also more immune to detrimental interference. With wavelength-division multiplexing (WDM) techniques, a single fiber-optic cable is capable of transmitting data over multiple channels that differ by the wavelength of the carrier optical beam. Since crosstalk between different spectral components of electromagnetic waves is weak in typical optical fibers, propagation of beams of different wavelengths (channels), e.g., λ₁, λ₂, . . . λ_{N}, occurs independently and with little interference. This facilitates parallel communication of information via different channels. A transmitting device can, therefore, impart individual modulations (which can be analog or digital) to different channels, combine (multiplex) the individual spectral components into a single beam, and transmit the combined beam via an optical fiber. A receiving device can split (demultiplex) the received beam back into multiple spectral components, extract modulation from each component, and convert the extracted modulation into the data carried by various spectral components (channels).

### BRIEF DESCRIPTION OF DRAWINGS

FIG. 1 is a schematic block diagram of an example computer architecture 100 capable of implementing vertically integrated wavelength-division optical technology, according to at least one embodiment;

FIGS. 2A-2B are block diagrams illustrating schematically architecture and operations of an optical transceiver with a vertically integrated wavelength-division device, according to at least one embodiment. FIG. 2A illustrates operations of the optical transceiver in the transmission mode; FIG. 2B illustrates operations of the optical transceiver in the reception mode;

FIG. 3A is a block diagram illustrating schematically a side view of a wavelength-division multiplexer/demultiplexer (WDM) device vertically integrated with an optical transceiver of FIGS. 2A-2B, according to at least one embodiment;

FIG. 3B is a block diagram illustrating schematically another vertically integrated WDM device, according to at least one embodiment.

FIG. 3C is a block diagram illustrating schematically a vertically integrated WDM block, according to at least one embodiment.

FIG. 4 is a block diagram illustrating schematically a top view of a vertically integrated WDM device having multiple linear arrays of optical elements collecting spectral beams from a photonic integrated circuit, according to at least one embodiment;

FIG. 5 is a block diagram illustrating schematically an optical device capable of vertically integrated wavelength-division multiplexing/demultiplexing, according to at least one embodiment;

FIG. 6 is a flow diagram of an example method of using an optical transceiver with a vertically integrated wavelength-division structure for fiber-optic communications, according to at least one embodiment;

FIGS. 7A-7B illustrate an example network architecture in which disclosed systems and techniques may be deployed, according to at least one embodiment;

FIG. 8 illustrates a fat tree topology for a datacenter, according to at least one embodiment; and

FIG. 9 illustrates an example network architecture capable of deploying vertically integrated wavelength-division optical technology, according to at least one embodiment.

### DETAILED DESCRIPTION

Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

Interconnections between devices may be implemented using fiber optic cables. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

For increased throughput and bandwidth, modern fiber-optic communication systems can support tens or even hundredth of channels. Transmitters, receivers, and combined transceiver devices can deploy optical connectors that interface between modulated beams, e.g., carried by various optical fibers and/or waveguides of a photonic integrated circuit (PIC), and an external optical fiber. Outcoupling of each separate beam with a different wavelength is typically performed using a separate coupler (e.g., a mirror, a diffraction grating, and/or a similar optical device). As a result, a large number of couplers has to be positioned on the PIC resulting in a relatively low density of transmitted data per external fiber-facing edge of the PIC (beachfront density). This, in turn, leads to increased size and cost of the transceivers. Designing large-bandwidth optical couplers capable of handling multiple wavelength channels is challenging. Therefore, in fiber-optic communications, achieving data a high density of transmitted data per external fiber-facing edge of the optical chip is desired.

Aspects and embodiments of the present disclosure address these and other challenges of the existing WDM technology and provide for vertically integrated optical connectors having a compact size and being capable of achieving high beachfront density using optical couplers, which may be any suitable optical elements (e.g., diffraction gratings, mirrors, etc.) that redirect light away from a plane of a PIC. In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber.

In some embodiments, a disclosed optical connector device includes an optical transceiver, e.g., a PIC, or some other optical chip device, that deploys multiple optical couplers supporting specific wavelengths (color coded channels). Optical couplers may be arranged in a one-dimensional (1D) array in a direction substantially along the optical fiber (to maximize the front signal density). An individual surface-emitting coupler may include any spectral component such as diffraction grating or a prism, one or more collimating or focusing lenses and/or mirrors, and/or other optical elements. A WDM device may be placed on the PIC, e.g., above the array of optical couplers, and may serve as a multiplexer (demultiplexer) by supporting a plurality of optical pathways that iteratively collect and combine individual beams (channels) directed by various optical couplers until all beams are combined into a single combined beam that is then directed to an external optical fiber. In reception, demultiplexing of the received beam may be performed in the opposite direction, starting from the received combined beam that is iteratively split into multiple individual spectral beams. In some embodiments, the WDM device may be permanently attached to the PIC. In some embodiments, the WDM device (or some part thereof) may be detachable from the PIC using mating connector(s).

To implement iterative multiplexing/demultiplexing, the WDM device may include a micro-optics WDM block (e.g., a combination of optical filters, mirrors, microlens, etc. placed on top of the PIC) that may be largely made from a transparent material. The WDM block may have a shape that accommodates multiple types of optical surfaces which may be affected by different types of surface treatment. The WDM block can be molded as part of the connector or assembled into the connector housing. For example, one side (e.g., a top side) of the WDM block may be coated with a highly reflective material to ensure reflection of multiple (e.g., all) spectral components at various points of their optical paths. Another side (e.g., a bottom side) of the WDM block may have multiple optical (e.g., film-based) filters operating as band-pass filters, e.g., transmitting (or reflecting) beams with wavelengths below a certain threshold while reflecting (or transmitting) beams with wavelengths above that threshold. In some embodiments, the number of such optical filters may match the number of optical couplers (which, in turn, may be equal to the number of channels). Yet other side(s) of the WDM block may be treated with an anti-reflective coating to minimize stray reflections. One or more focusing and/or collimating optical elements may interface between the WDM block and an external optical fiber to facilitate smooth and lossless communication of the combined beam produced by the WDM block. The collimating optical elements may include an optical fiber array with either collimating micro-lens (μLens) assembled at the front of the fiber tip or cleaved/special treated fiber tip to collimate the light coming out of the fiber core to support multiple parallel paths. In some embodiments, a two-dimensional (2D) array of optical couplers with a matching WDM block may be used, e.g., where a first portion of the WDM bock iteratively collects beams outcoupled by individual couplers within 1D arrays of couplers and a second portion of the WDM combines beams collected by those individual 1D arrays.

The WDM systems and transceivers of the present disclosure are capable of supporting efficient high-density connectivity while being vertically integrated on narrow-sized optical integrated circuits to maximize lateral density of communicated data. The disclosed WDM systems and transceivers can fully and efficiently utilize the surface area of the transceiver integrated circuits to implement high beachfront density and high bandwidth signal transmission without increasing the transceiver beachfront size in the lateral dimension to the direction of an external optical fiber or fiber array, which may have a pitch of 127 μm, 250 um, and/or the like.

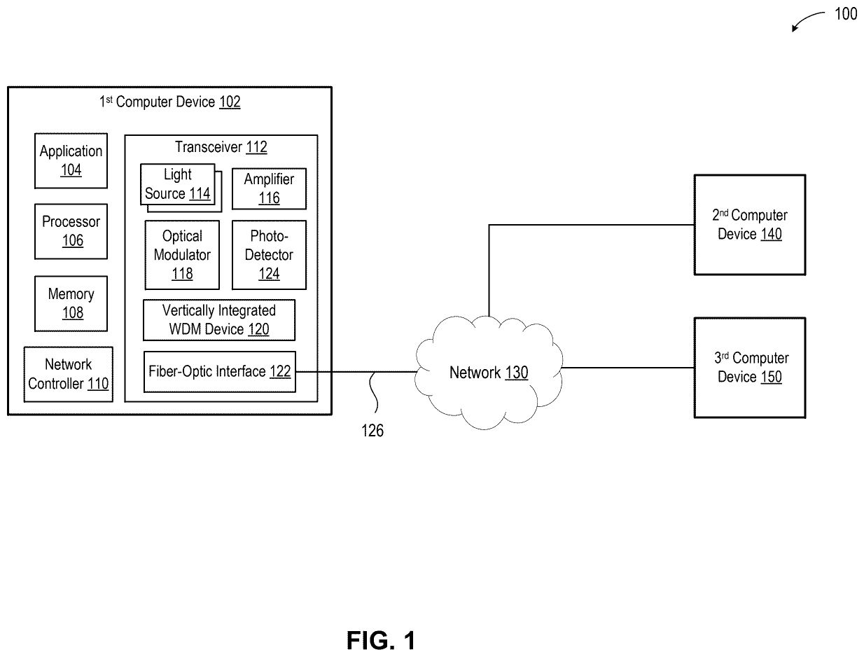

FIG. 1 is a schematic block diagram of an example computer architecture 100 capable of implementing vertically integrated wavelength-division optical technology, according to at least one embodiment. As depicted in FIG. 1, computer architecture 100 may include multiple computing devices, e.g., a first computer device 102, a second computing device 140, a third computing device 150, and/or the like, which may be connected via a network 130. Network 130 can be a public network (e.g., the Internet), a private network (e.g., a local area network (LAN), or wide area network (WAN)), a wireless network, a personal area network (PAN), or a combination thereof. Various components of computer devices are illustrated below using first computer device 102 as an example, but other computer devices (e.g., second computer device 140, third computing device 150, etc.) may include the same or similar components.

First computer device 102 can support one or more applications 104 that can transmit and/or receive data over network 130 and/or direct connections (e.g., over any suitable bus or interconnect, not shown in FIG. 1) to/from other computer devices. Applications 104 may include, or be related to, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing, and/or any other suitable applications.

Various computational processes of applications 104 may be supported by one or more processors 106, including any number of graphics processing units (GPUs), central processing units (CPUs), parallel processing units (PPUs), data processing units (DPUs), accelerators, field-programmable gate arrays (FPGAs), application-specific integrated circuits (ASICs), and/or other suitable processing devices. Processor(s) 106 may be communicatively coupled to one or more memory devices 108. Memory device(s) 108 may include any volatile or non-volatile memory, such as a read-only memory (ROM), a random-access memory (RAM), electrically erasable programmable read-only memory (EEPROM), flash memory, flip-flop memory, or any other device capable of storing data. RAM may include a dynamic random-access memory (DRAM), synchronous DRAM (SDRAM), static random-access memory (SRAM), and the like. In some embodiments, memory device(s) 108 may be, or include, an on-chip memory. In some embodiments, processor(s) 106 and memory device(s) 108 may be implemented as a single unit, e.g., as a FPGA unit.

Transmission and/or reception of data by first computer device 102 may be facilitated by a suitable network controller (network adapter, network interface card, etc.) 110 supporting any suitable communication protocol, e.g., WDM protocol, Synchronous Optical Networking (SONET) protocol, Synchronous Digital Hierarchy (SDH) protocol, Optical Transport Network (OTN) protocol, and/or any other suitable protocol. Network controller 110 may include any combination of hardware components and software modules that ensures communication of data over network 130 and/or other suitable communication pathways (e.g., local busses/interconnects) and serves as an intermediary between first computer device 102 and the infrastructure of network 130, including maintaining an inventory of devices connected to network 130, managing and configuring protocols for communication with network 130, deploying protocol stacks, and/or the like. Network controller 110 may maintain a queue of data scheduled for transmission by application(s) 104, encrypt the data, apportion the data into frames and/or packets that can be transmitted over network 130, add any suitable header information to the packets and schedule the packets for transmission via a transceiver 112. Similarly, network controller 110 may receive, from transceiver 112, packets communicated over network 130 by other computer devices (e.g., second computer device 140, third computer device 150, and/or the like), transform packets into frames of data, decrypt received frames, place data in memory device 108 and/or otherwise make the received data available to application(s) 104 and/or processor(s) 106.

Transceiver 112 may include a combination of optical and electronic circuits that use a stream of digital transmitted electronic signals (e.g., bit values 0 and 1) corresponding to packets generated by network controller 110 and output optical beams that are communicated over an optical communication channel 126, which may include one or more optical fibers, via network 130. Similarly, transceiver 112 may receive optical beams from network 130 through the optical communication channel 126, extract the data encoded in the beams into a stream of digital received electronic signals corresponding to received packets of data that may be processed by network controller 110. In some embodiments, the same transceiver 112 may support both transmission and reception of data. In some embodiments, separate transmitter and receiver may be used to implement techniques disclosed herein.

Transceiver 112 may include one or more light sources 114, e.g. light-emitting diodes, laser diodes, semiconductor lasers, and/or the like to generate one or more light beams. In some embodiments, light beams may have sufficiently different frequencies (or, equivalently, wavelengths) so that there is no or little spectral overlap between different beams. Such beams are referred to as spectrally separated beams or, simply, spectral beams herein. For example, nth channel may use spectral beam having a range of wavelengths (λₙ−δλₙ, λₙ+δλₙ), where λₙ is the central wavelength for the channel and δλₙ is the channel's halfwidth. In some embodiments different (adjacent) may be separated in the wavelength space, e.g., such that the distance between the central wavelengths of two channels, e.g., n and n+1, are separated by a value that is greater than the sum of the channels' halfwidths, λₙ₊₁−λₙ<δλₙ+δλₙ₊₁, to avoid or reduce cross-channel interference. In the following, a reference to a specific wavelength λ should be also understood as a range of wavelengths around this wavelength λ.

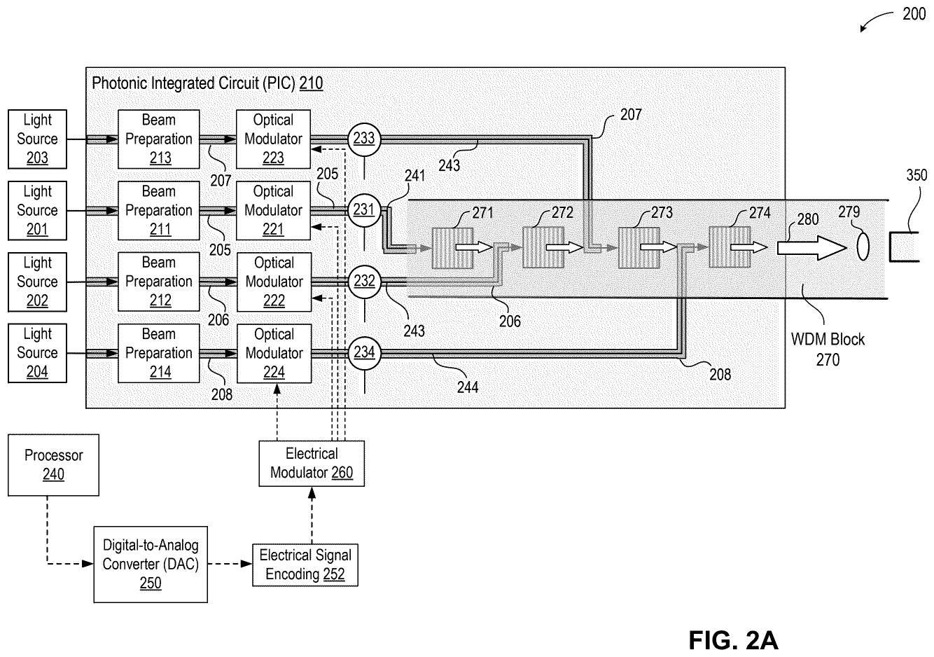

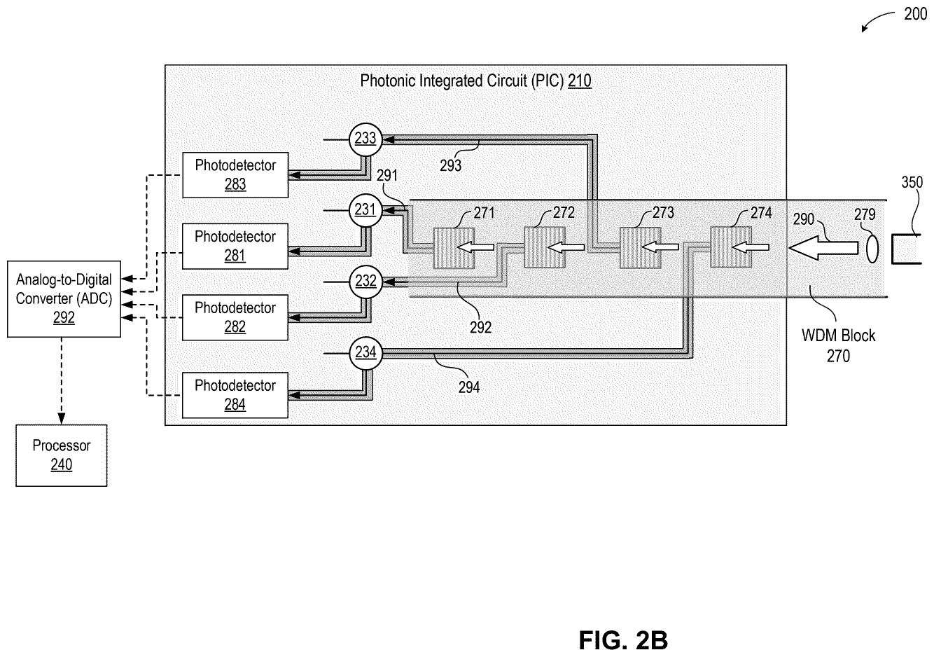

Transceiver 112 may include one or more optical modulators 118 to impart data-carrying modulation to the spectral beams, including but not limited to electro-absorption modulators, Mach-Zehnder interferometers, acousto-optic modulators, electro-optic modulators, and/or any other suitable modulators. Transceiver 112 may further include one or more optical amplifiers 116 that enhance intensity of the (modulated or unmodulated) beams, including but not limited to erbium-doped fiber amplifiers (EDFA), or other similar optical amplifiers. Transceiver 112 may further include a vertically integrated WDM device 120 to maximize beachfront density of communicated data, as disclosed in more detail in conjunction with FIGS. 2-5 below. Vertically integrated WDM device 120 may iteratively combine various spectral beams and provide the combined beam to a fiber-optic interface 122 that directs the light to the optical communication channel 126. When operating in a reception mode, transceiver 112 may receive a combination of multiple spectral beams from the optical communication channel 126 through fiber-optic interface 122. The vertically integrated WDM device 120 operating in reverse may demultiplex the received beam into a plurality of modulated spectral beams. One or more photodetectors 124 may then extract data-carrying modulation of the individual spectral beams. Transceiver 112 may also use additional components (not shown in FIG. 1), e.g., analog-to-digital converters (ADCs), Fourier analyzers, digital filters, and/or the like, to generate digital data that can be provided to network controller 110 for further processing according to one or more communication protocols supported by network controller 110.

FIGS. 2A-2B are block diagrams illustrating schematically architecture and operations of an optical transceiver 200 with a vertically integrated wavelength-division device, according to at least one embodiment. FIG. 2A illustrates operations of the optical transceiver 200 in the transmission mode; FIG. 2B illustrates operations of the optical transceiver 200 in the reception mode. It should be understood that optical transceiver 200 may support simultaneous transmission, reception, and processing of optical signals as illustrated by the combination of FIG. 2A and FIG. 2B and that the separate figures are merely intended for the convenience of illustration.

As illustrated in FIG. 2A, optical transceiver 200 may include multiple light sources 201-204, each producing one or more beams of light. Although, for brevity and conciseness, only four light sources 20n are shown, any other number of light sources 20n may be deployed by optical transceiver 200, including tens or more of light sources. “Beams” should be understood herein as referring to any signals of electromagnetic radiation, such as continuous beams, wave packets, pulses, sequences of pulses, or other types of optical electromagnetic signals. Solid and open arrows in FIG. 2A (and other figures) indicate propagation of optical signals whereas dashed arrows depict propagation of electrical (e.g., analog) signals or electronic (e.g., digital) signals.

Light sources 20n may include lasers, e.g., semiconductor lasers, gas lasers, laser diodes, light-emitting diodes (LEDs), and/or the like or any combination thereof. Light sources 20n may operate as continuous-wave light sources, single-pulse light sources, repetitively pulsed light sources, mode-locked light sources, and/or the like. Beams produced by light sources 204 may be delivered, e.g., via optical fibers or free space, to a photonic integrated circuit PIC 210 for further processing. In some embodiments, beams produced by light sources 20n may be received by PIC 210 via one or more directional switches, edge couplers, etc., that direct the incoming light within the plane of PIC 210, e.g., into a network of optical interconnects 205, 206, 207, 208, etc. that facilitate propagation of light within PIC 210. Optical interconnects 205-208 may include single-node or multi-node waveguides, including semiconductor (silicon, etc.) waveguides, optical fibers, and/or other devices capable of guiding light beams. Although not explicitly illustrated in FIG. 2A, any, some, or all light sources 20n may be integrated into PIC 210. Although illustrated as part of optical transceiver 200 in FIG. 2A, in some embodiments, any, some, or all light sources 201-204 may be located outside optical transceiver 200, e.g., as an attachable/detachable unit.

PIC 210 may be any type of photonic integrated circuit. For example, PIC 210 may be an electro-optic modulator, a photodiode, a transmitter optical sub assembly and/or a receiver optical sub assembly. In some embodiments, PIC 210 may include graphene. In some embodiments, there may be more than one PIC supported by a common substrate. In some embodiments, the substrate may also support one or more electronic integrated circuits. In some embodiments, PIC 210 may support a plurality of cable connectors (not shown in FIG. 2A). In some embodiments, cable connectors may be flexible. This may help ensure that the cable connectors may be used with a variety of substrates, electronic integrated circuits, and photonic integrated circuits. For example, the substrate, electronic integrated circuit(s), and/or photonic integrated circuit(s) may be from different manufactures, may be a different type of integrated circuit or substrate, and/or may have different capabilities. For example, the substrate, the electronic integrated circuit(s), and the photonic integrated circuit(s) may have different heights Flexible of cable connectors may be able to bend as needed, such that various components with different heights may be accommodated and connections may be made without any additional modifications. Additionally, flexible cable connectors may be used with a variety of substrates, electronic integrated circuits, and photonic integrated circuits that have interconnect connectors with different pitches.

PIC 210 may facilitate formation of optical beams with specific amplitude, phase, spectral, and polarization characteristics and encoding digital signals into the beams, e.g., using a number of passive and/or active optical elements. In some embodiments, beams of light generated by light sources 20n may undergo a suitable preprocessing using respective beam preparation stages 211-214 that modify various properties of the beams, including but not limited to spectrally filtering the beams, e.g., reducing beam linewidths, imparting polarization (e.g., circular or linear) to the beams, amplifying the beams, and/or modifying the beams in any other suitable way. In some embodiments, any, some, or all operations of beam preparation stages 211-214 may be performed prior to receiving the beams by PIC 210. Beam preparation stages 211-214 may include filters, resonators, polarizers, feedback loops, lenses, mirrors, diffraction optical elements, optical amplifiers, lock-in amplifiers, and/or other optical devices. In some embodiments, one or more of light sources 201-204 may be a broadband light source with a beam generated by such a light source subsequently filtered using a narrowband filter of a respective beam preparation stage 21n.

Optical modulators 221-224 may modulate the beams to encode any digital or analog data into the beams. Optical modulation may include any form of phase modulation (including imparting any temporal sequence of phase shifts imparted to the beams), frequency modulation (including imparting any temporal sequence of frequency changes), and/or amplitude modulation (including imparting any temporal variation of the amplitude of the beams), and/or any combination thereof.

In some embodiments, optical modulators 221-224 may include an acousto-optic modulator (AOM), an electro-optic modulator (EOM), a Lithium Niobate modulator, a heat-driven modulator, a Mach-Zehnder modulator, and the like, or any combination thereof. In some embodiments, optical modulators 221-224 may include a quadrature amplitude modulator (QAM) or an in-phase/quadrature modulator (IQM). In one example, optical modulators 221-224 may operate via electrical or mechanical control exercised over the refractive index of an optical medium of the optical modulators.

In some embodiments, optical modulation of the beams may be imparted using an electrical modulator 260, which may be (or include) a radio frequency (RF) modulator, a terahertz (THz) modulator, a microwave modulator, and/or a modulator operating in any other suitable range of frequencies. Electrical modulator 260 may generate and apply electrical signals to optical modulators 221-224 to implement optical encoding. In some embodiments, electrical modulator 260 may include one or more local oscillators, mixers, amplifiers, and/or filters of electrical signals, and/or the like. Electrical modulator 260 may impart optical modulation individually to each optical modulator 221-224 in accordance with any suitable electrical signal encoding 252 generated using a digital-to-analog converter (DAC) 250 that converts a digital signal generated by a processor 240 for transmission via optical transceiver 200.

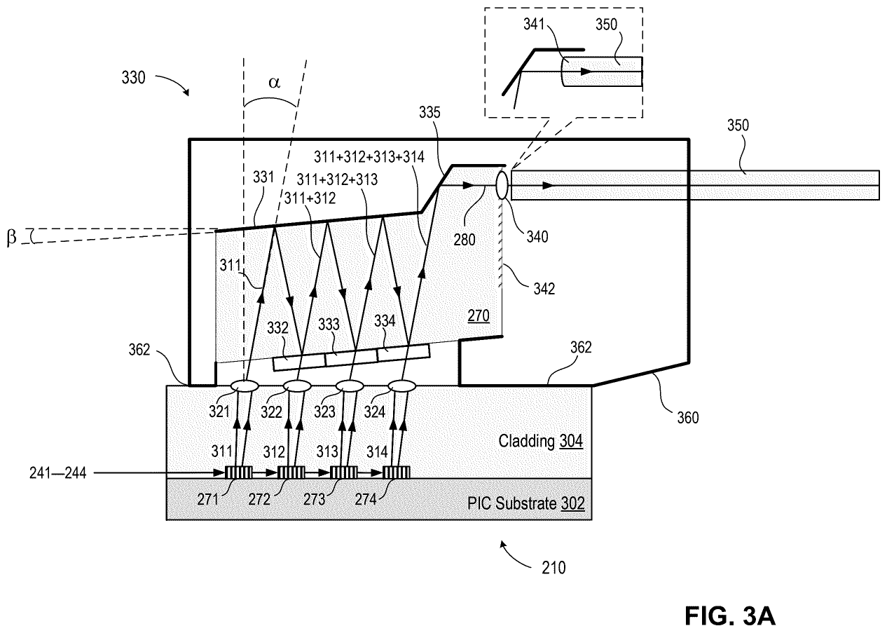

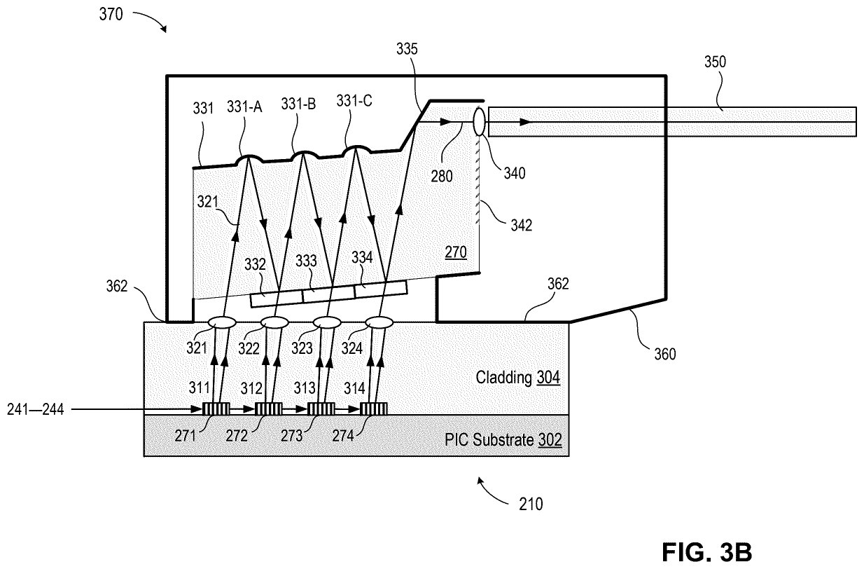

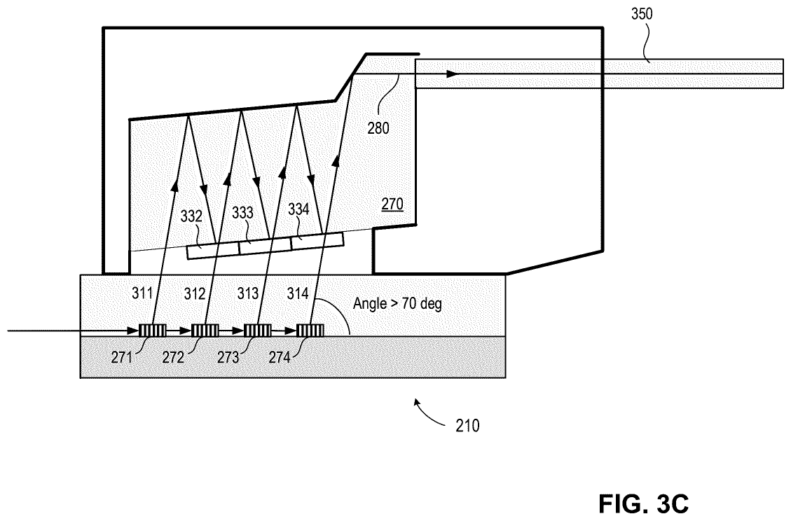

Spectral beams 241-244 modulated using optical modulator 220 may be delivered to a wavelength-division multiplexing/demultiplexing (WDM) block 270 described in more detail in conjunction with FIG. 3A below. In some embodiments, prior to being delivered to WDM block 270, spectral beams 241-244 may pass through respective directional couplers 231-234 that separate transmitted beams (e.g., spectral beams 241-244) from received beams (e.g., as illustrated with FIG. 2B below). Directional couplers 231-234 may include beam splitters, grating couplers, optical circulators, e.g., Faraday effect-based circulators, birefringent crystal-based circulators, and/or the like.

Prior to being delivered to WDM block 270, spectral beams 241-244 may be processed by a suitable set of optical amplifiers (not shown in FIG. 2A), which may include Erbium-doped amplifiers, waveguide-integrated amplifiers, saturation amplifiers, and/or the like, of some combination thereof.

WDM device 330 may further include optical couplers 271-274 that direct, e.g., via reflection, scattering, diffraction, etc., spectral beams 241-244 away from the plane of the PIC 210 and towards WDM block 270. (FIG. 2A illustrates the top view of WDM block 270 positioned above optical couplers 271-274 of PIC 210.) As illustrated below in conjunction with FIG. 3A, WDM block 270 may include multiple optical elements that iteratively combine redirected spectral beams 241-244 into a combined beam 280 that is then directed, e.g., via an optical fiber interface 279 (e.g., lens, microlens, rounded optical fiber tip, etc.), to an optical fiber 350 to be communicated to an external computing device or network.

As illustrated in FIG. 2B, when operated in the reception mode, optical transceiver 200 may receive a combined beam 290 that includes multiple spectral components (beams), each beam carrying its own digital signal encoded in the modulation of the respective beam. In some embodiments, WDM block 270 may include optical elements whose functions are time-reversible, such that when output beam(s) are reversed (e.g., when transmission beam becomes a received beam), the light retraces its path in the reverse direction. More specifically, received combined beam 290 may be processed by various optical elements of WDM block 270 (as disclosed in conjunction with FIG. 3A) to iteratively demultiplex the received combined beam 290 into individual spectral beams 291-294, each individual beam directed by a corresponding optical coupler 271-274 into the plane of the PIC 210 and associated with a specific wavelength or a range of wavelengths of a particular channel carrying a modulated signal, e.g., as may be prepared and encoded by any suitable sending device.

Received spectral beams 291-294 may be processed by respective directional couplers 231-234 that direct the beams away from the transmission components of optical transceiver 200 (e.g., away from light sources 201-204, beam preparation stages 211-214, optical modulators 221-224, and/or other components) and towards a set of photodetectors 281-284. In some embodiments, instead of using the same optical fiber 350 for communication and transmission of optical beams, received beam 290 may be received via a dedicate reception optical fiber. In such embodiments, directional couplers 231-234 may not be used since transmitted and received optical beams follow separate paths.

Photodetectors 291-294 may extract optical modulation of the received beams and generate analog electrical signals representative of the extracted modulation. Individual photodetectors 281-284 may operate in its specific wavelength domain corresponding to the respective received spectral beams 291-294. For example, photodetector 281 may operate in the range of green light, photodetector 282 may operate in the range of red light, photodetector 283 may operate in a range of yellow light, photodetector 284 may operate in a range of blue light, and/or the like.

In some embodiments, an individual photodetector 28n may be arranged into a 180-degree optical hybrid stage, a 90-degree optical hybrid stage, and/or the like that also receives, as additional reference inputs, unmodulated beams of the corresponding wavelength range. For example, photodetector 281 may receive an unmodulated reference green light. In some embodiments, the unmodulated reference light may be a local oscillator (LO) copy of the corresponding light (of the same wavelength range) generated by one of light sources 201-204 (with reference to FIG. 2A) whose reference copy is maintained on PIC 210 for use in photodetection. Photodetector 281 (and/or any other photodetectors 282-284) may generate an electrical signal representative of a difference between received spectral beam 291 and the reference beam.

In some embodiments, an individual photodetector may include photodiodes connected in series (balanced photodetection setup) that generate electrical signals proportional to a difference of intensities of the input optical modes. A balanced photodetector may include a pair of photodiodes that are Si-based, InGaAs-based, Ge-based, Si-on-Ge-based, and/or the like.

The generated electrical signals may be analog signals, in some embodiments. An Analog-to-Digital converter (ADC) 292 may digitize the electrical signal and provide the digitized signal for further processing by processor 240 into a sequence of bits encoded in the modulation of the received beam (e.g., any of the received spectral beams 291-294).

In some embodiments, processor 240 may include a dedicated digital signal processing (DSP) circuitry for processing electrical signals generated by photodetectors 281-284 (e.g., accelerator circuitry). The DSP (not shown in FIG. 2B) may include spectral analyzers, such as Fast Fourier Transform (FTT) analyzers, and other circuits configured to process digital signals, including central processing units (CPUs), graphic processing units (GPUs), field-programmable gate arrays (FPGAs), application-specific integrated circuits (ASICs), etc., and one or more memory devices. In some embodiments, the processing and memory circuits can be implemented as part of a DSP microcontroller.

In some embodiments, an optical transceiver may include multiple WDM blocks 270, each individual block supporting multiple wavelength transmission and reflection channels through several optical fibers 350. In one example, embodiment, an optical transceiver may support 8×4=32 communication channels, e.g., with eight WDM blocks, each supporting 4 wavelength channels λ₁, λ₂, λ₃, λ₄. In such embodiments, four light sources (e.g., light sources 201-204) may generate four initial beams, each beam subsequently split into eight separate beams independently modulated with different signals. Each of eight WDM block 270 supports transmission and reception of four wavelength channels λ₁, λ₂, λ₃, λ₄. An optical transceiver supporting this 32-channel transmission/reception may deploy 20 optical fibers (or waveguides), e.g., with four fibers delivering light from the light sources, eight fibers delivering transmitted beams from optical modulators (e.g., optical modulators 221-224) to corresponding WDM blocks, and eight fibers delivering received beams from the WDM blocks to corresponding photodetectors.

FIG. 3A is a block diagram illustrating schematically a side view of a wavelength-division multiplexer/demultiplexer (WDM) device 330 vertically integrated with an optical transceiver of FIGS. 2A-2B, according to at least one embodiment. In some embodiments, WDM device illustrated in FIG. 3A may include WDM block 270 of FIGS. 2A-2B. Even though FIG. 3A illustrates operations of the WDM device in the transmission mode, operations of the WDM device 330 in the reception mode may be performed in a substantially the same way, with directions of various beams reversed (see, e.g., FIG. 2B).

As illustrated in FIG. 3A, WDM device 330 may be mounted on PIC 210. PIC 210 may include one or more layers, e.g., a chip or substrate 302 and a cladding 304 (not to scale). Substrate 302 may be or include a silicon layer, a germanium layer, a corundum layer, a glass layer, and/or any other suitable layer capable of supporting various elements and components of PIC 210. Cladding 304 may protect optical elements (e.g., optical interconnects, modulators, waveguides, photodetectors, and/or any other elements) of PIC 210 from various external and environmental factors, conditions, and impacts. In some embodiments, cladding 304 may include a transparent layer, e.g., a glass layer, a silicon oxide layer, and/or a layer of any other suitable transparent material.

Substrate 302 may host a fabric of optical interconnects (e.g., waveguides, optical fibers, etc.) that deliver modulated spectral beams 241-244 from various elements of PIC 210, e.g., optical modulators 221-224 (with reference to FIG. 2A), to optical couplers 271-274. As disclosed in conjunction with FIG. 2A and FIG. 2B, optical couplers 271-274 may be surface-emitting couplers that direct at least a portion of the energy of spectral beams 241-244 away from the plane of the PIC 210. Optical couplers 271-274 may include diffractive optical elements, prisms, reflectors, scatterers, and/or the like. The redirected, by optical couplers 271-274, spectral beams 311-314 may have a certain angular spread caused by dispersion of light upon interaction with optical couplers 271-274 that can cause loss of energy of the spectral beams, which can be the more significant the longer an optical path of a corresponding spectral bema is. To prevent such losses, the angular dispersion may be compensated by an array of lenses 321-324 that collimate and/or partially focus spectral beams 311-314. Collimated spectral beams 311-314 may enter WDM device 330 that serves as a multiplexer iteratively combining spectral beams 311-314 into combined beam 280 (or a demultiplexer separating received combined beam into spectral components).

In some embodiments, array of lenses 321-324 that collimates spectral beams 311-314 may be integrated as part of WDM block 270. In some embodiments, array of lenses 321-324 may be implemented as part of PIC 210 (e.g., as illustrated in FIG. 3A).

In one example embodiment, a WDM block 270, which may be made from a transparent material, e.g., glass, may support multiple optical elements. For example, a top side of the WDM block 270 may be coated with a highly reflective material to form a first reflecting surface 331, also referred as to as a first reflecting region herein. First reflecting surface 331 may reflect various spectral components of the beams. A bottom surface of the WDM block 270 may include multiple optical filters 332, 333, 334, etc., which may be operating as band-pass filters performing selective transmission and reflection of light, e.g., transmitting (or reflecting) signals with wavelengths below a certain threshold while reflecting (or transmitting) signals with wavelengths above that threshold. For example, optical filter 332 may reflect red light corresponding to the wavelengths λ_{R} of spectral beam 311 but transmit yellow light corresponding to the wavelengths λ_{Y} of spectral beam 312. As a result, light propagating from optical filter 332 to the first reflecting surface 331 may include the combination λ_{R}+λ_{Y} of the red light and the yellow light. Similarly, optical filter 333 may reflect both the red light λ_{R} and yellow light λ_{Y} but transmit green light corresponding to the wavelengths λ_{G} of spectral beam 313. As a result, light propagating from optical filter 333 to the first reflecting surface 331 may include the combination λ_{R}+λ_{Y}+λ_{G} of the red light, yellow light, and green light. Optical filter 334 may reflect red light λ_{R}, yellow light λ_{Y}, and green light λ_{G} but transmit blue light corresponding to the wavelengths λ_{B} of beam 314. The light propagating away from optical filter 334 may, therefore, include the combination λ_{R}+λ_{Y}+λ_{G}+λ_{B} of red light, yellow light, green light, and blue light. Although, for brevity and conciseness, four beams and four optical filters are illustrated in FIG. 3A, any number of optical filters may be used to combine the corresponding number of spectral beams.

Combined beam 280 that includes iteratively collected spectral beams 311-314 may be reflected by a second reflecting surface 335 (also referred as to as a second reflecting region herein) that directs the combined beam 280 towards an interface with an external optical fiber 350. In some embodiments, the optical fiber interface may include one or more optical elements, e.g., a focusing lens 340 (as shown), a focusing (e.g. parabolic) mirror, and/or other suitable optical elements. In some embodiments, e.g., as illustrated with the callout portion of FIG. 3A, a curved (rounded) tip 341 of optical fiber 350 may be used in lieu of a focusing lens to direct/light into optical fiber 350. The curved surface of tip 341 may focus/guide various spectral components of the combined beam 280 into optical fiber 350.

As a result, WDM block 270 uses multiple reflections of spectral beams 311-314 from the first reflecting surface 331 to form a single combined beam 280 and then uses the second reflecting surface 335 to reflect the light one more time and couple (direct) the light into optical fiber 350. Horizontal positioning of optical fiber 350 minimizes the height of WDM block 270 and housing 360.

In various embodiments, spectral beams 311-314 and WDM block 270 may have a variety of relative orientations. In some embodiments, spectral beams 311-314 may make an angle of departure a with the normal direction to the PIC 210 that is less than 10 degrees, α<10°, and first reflecting surface (region) 331 makes an angle β that is more than 5 degrees with the plane of the PIC 210, β>5°. In one example, spectral beams 311-314 may be directed vertically up (α=0°) and the redirection of spectral beams 311-314 towards optical filters 332-334 may be achieved by the angled first reflecting surface 331. In some embodiments, α>5°, and β<5°. In one example, first reflecting surface 331 may be parallel to the plane of the PIC 210 (β=0°) while the redirection of spectral beams 311-314 may be achieved by a suitable selection of the angle of departure a of spectral beams 311-314 from the plane of the PIC 210. In some embodiments, a combination of both techniques may be used, by tuning both the angle of departure and the angle of the first reflecting surface, e.g., α>5°, β>5°. In some embodiments, angle α can be more than 5° but less than 20°, 5°<α<20°, such that the angle that spectral beams 311-314 make with the plane of the optical chip, 90°−α, may exceed 70 degrees.

In some embodiments, WDM block 270 may be enclosed in a housing 360 that affixes WDM block 270 to PIC 210. In some embodiments, housing 360 may include one or more mechanical couplers 362, e.g., pins, brackets, joints, detents, etc., that engage one or more matching couplers (not shown in FIG. 3A) on PIC 210 to removably affix WDM block 270 to PIC 210. In some embodiments, mechanical coupler(s) 362 may be integrated into housing 360. In some embodiments, mechanical coupler(s) 362 may also be removably coupled to housing 360.

FIG. 3A illustrates a single linear array of optical couplers 271-274 arranged in a linear array positioned along the direction of the combined beam 280. In some embodiments, PIC 210 may support multiple linear arrays of optical couplers with WDM block 270 including multiple matching arrays of optical filters, mirrors, and/or other optical elements, e.g., lenses, and/or the like.

As disclosed in conjunction with FIG. 3A, in some embodiments, a wavelength-division multiplexing device (e.g., WDM device 330) may include a plurality of optical elements (e.g., optical filters 332, 333, 334, and/or the like) arranged in one or more linear arrays and configured to receive a plurality of spectral beams (e.g., spectral beams 311, 312, 313, 314). An individual optical element of the plurality of optical elements may be configured to reflect one or more spectral beams of the plurality of spectral beams and transmit one or more other spectral beams of the plurality of spectral beams. For example, optical filter 332 may reflect spectral beam 311 but reflect spectral beam 312, optical filter 333 may reflect spectral beam 311 and 312 but reflect spectral beam 313 and so on. The wavelength-division multiplexing device may further include a first reflecting surface (e.g., first reflecting surface 331) configured to reflect the plurality of spectral beams towards the plurality of optical elements. The wavelength-division multiplexing device may further include a second reflecting surface (e.g., second reflecting surface 335) configured to reflect an output beam towards an output optical interface (e.g., lens 340), the output beam (e.g., combined beam 280) formed by iterative reflections of the plurality of spectral beams from the first reflecting surface and at least some of the plurality of optical elements, and wherein the output optical interface is configured to optically couple to an external optical fiber (as illustrated in FIG. 3A). The wavelength-division multiplexing device may also include one or more mechanical couplers (e.g., mechanical couplers 362) configured to affix the wavelength-division multiplexing device to an optical chip device (e.g., PIC 210). As disclosed in conjunction with FIG. 2A and FIG. 3A, in some embodiments, an optical transceiver may include a photonic integrated circuit (e.g., PIC 210 in FIG. 2A). The photonic integrated circuit may include one or more optical modulators (e.g., optical modulators 221, 222, 223, 224) to encode a transmitted electronic signal in a plurality of spectral beams (e.g., spectral beams 205, 206, 207, 208). The photonic integrated circuit may further include a plurality of optical couplers (e.g., optical couplers 271, 272, 273, 274). An individual optical coupler of the plurality of optical couplers may be configured to direct a respective spectral beam away from a plane of the photonic integrated circuit. The photonic integrated circuit may also include a plurality of optical interconnects (e.g., optical interconnects 241, 242, 243, 244). An individual optical interconnect of the plurality of optical interconnects may be configured to deliver the respective spectral beam of the plurality of spectral beams to the individual optical coupler. For example, optical interconnect 205 may deliver spectral beam 241 to optical coupler 271. The photonic integrated circuit may further include a wavelength-division multiplexing block (e.g., WDM block 270) that includes a plurality of optical elements configured to iteratively combine the plurality of spectral beams into a combined beam and an optical fiber interface (e.g., lens 340) configured to direct the combined beam (e.g., combined beam 280) to an external optical fiber (e.g., external optical fiber 350). In some embodiments, the plurality of optical elements of the WDM block may include (e.g., as illustrated in FIG. 3A), optical filters 332, 333, 334, first reflecting surface 331, second reflecting surface 335, and/or the like. In some embodiments, the plurality of optical elements of the WDM block may include one or more lenses 321, 322, 323, 324.

The WDM device 330 disclosed in conjunction with FIG. 3A facilitates increasing the transmitted/received beachfront density by the number of WDM channels. For example, a typical optical transceiver with 127 um pitch 1D FAU (either surface-coupled or edge-coupled) and supporting a 200 Gb per fiber bandwidth can theoretically achieve approximately 0.8 Tb/mm beachfront density in theory. In contrast, the disclosed WDM device 330 deploying four optical couplers 321, 322, 323, 324 and WDM block 270 to vertically direct and combine four spectral beams 311, 312, 313, 314 into a single combined beam 280 may improve the beachfront density four-fold to about 3.2 Tb/mm. In some embodiments, the beachfront density may be less than 3.2 Tb/mm, e.g., between 2.0 Tb/mm and 2.4 Tb/mm, between 2.4 Tb/mm and 2.8 Tb/mm, between 2.8 Tb/mm and 3.2 Tb/mm. Further improvement of the beachfront density above 3.2 Tb/mm may be achieved with additional optical couplers.

FIG. 3B is a block diagram illustrating schematically another vertically integrated WDM device 370, according to at least one embodiment. WDM device 370 has a first reflecting surface 331 with a set of curved (dome-shaped) portions 331-A, 331-B, 331-C, etc., which may be used for additional collimation (or re-focusing) of spectral beams. In some embodiments, curved portions 331-A, 331-B, 331-C may be deployed to reduce the spacing between optical filters 332, 333, 334 to make the WDM device 370 more compact in the longitudinal direction (along external optical fiber 350). In some embodiments, rather than having multiple curved portions 331-A, 331-B, 331-C, the first reflecting surface 331 may be curved.

FIG. 3C is a block diagram illustrating schematically a vertically integrated WDM block 270, according to at least one embodiment. WDM block 270 is configured to receive multiple spectral beams 311, 312, 313, 314 directed away from a plane of a photonic integrated circuit 210 at an angle 70 degrees or more to the plane. WDM block 270 of FIG. 3C is further configured to combine the multiple spectral beams 311, 312, 313, 314 into a combined beam 280 and output the combined beam to an external optical fiber 350.

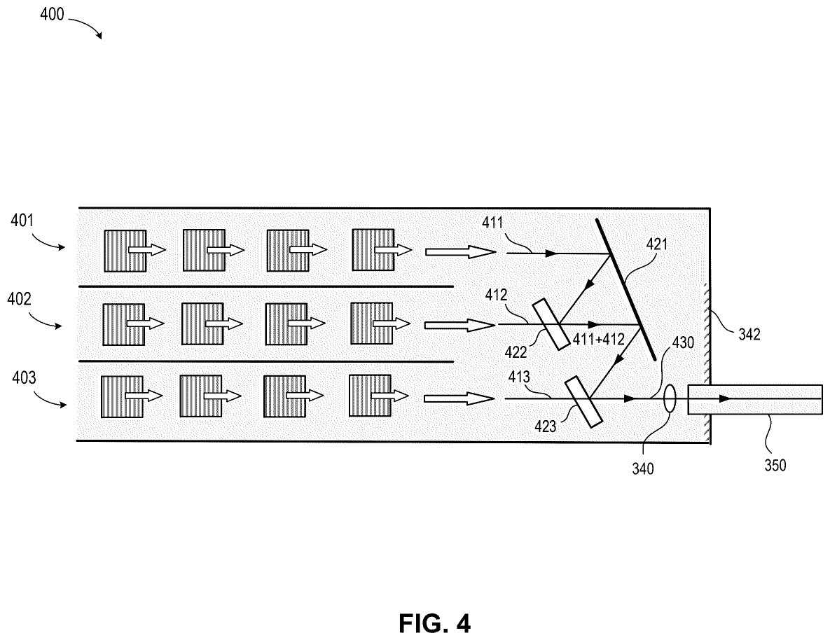

FIG. 4 is a block diagram illustrating schematically the top view of a vertically integrated WDM device 400 having multiple linear arrays of optical elements collecting spectral beams from a photonic integrated circuit, according to at least one embodiment. As illustrated, WDM device 400 collects spectral beams from three linear arrays 401, 402, and 403 of optical couplers. Spectral beams collected from each linear array 40n may be combined into corresponding intermediate beams 411, 412, and 413, e.g., substantially as disclosed in conjunction with FIG. 2A and FIG. 3A. WDM block 400 may further include a reflecting surface (e.g., mirror) 421 that reflects a first intermediate beam 411 towards optical filter 422 that reflects spectral components λ₁, . . . λ₄ of first intermediate beam 411 while transmitting spectral components λ₅ . . . λ₈ of second intermediate beam 412. The combination 411+412 is redirected by reflecting surface 421 towards optical filter 423 that similarly reflects spectral components λ₁ . . . λ₈ of the combination 411+412 while transmitting spectral components λ₉ . . . λ₁₂ of a third intermediate beam 413. This forms a final combined beam 430 that may be focused by lens 340 towards an interface with an external optical fiber 350. Although three arrays of four optical couplers each are shown in FIG. 4, the number of optical couplers need not be limited, e.g., with M arrays of N optical couplers and the corresponding number of optical filters, collimating lenses, and/or other optical elements that may first collect N spectral beams within each individual array into M intermediate beams and subsequently combine these intermediate beams into a final combined beam, which is directed to external optical fiber 350. In some embodiments, M may be larger than N, e.g., as shown in FIG. 4. In some embodiments, M may be substantially larger than N, e.g., by the aspect ratio 1.5, 2, 3, 4, or some other number. In one example, M may be at least 4 and N may be at least 10 (e.g., 10, 20, etc.).

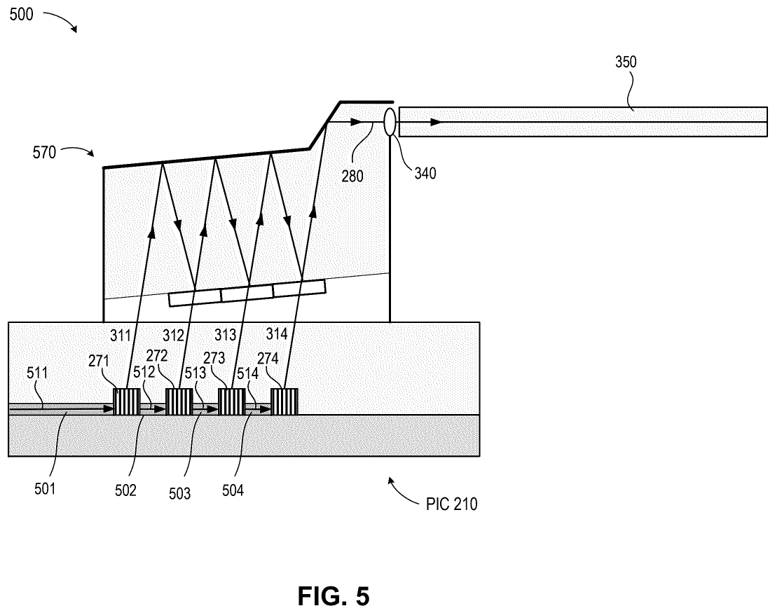

FIG. 5 is a block diagram illustrating schematically an optical connector device 500 capable of vertically integrated wavelength-division multiplexing/demultiplexing, according to at least one embodiment. As illustrated, the optical connector device 500 includes a photonic integrated circuit 210. The photonic integrated circuit 210 includes a plurality of optical interconnects 501, 502, 503, 504. An individual optical interconnect 50n of the plurality of optical interconnects 501-504 is configured to support propagation of a respective spectral beam 51n of a plurality of spectral beams 511, 512, 513, 514. The photonic integrated circuit 210 further includes a plurality of optical couplers 271, 272, 273, 274. An individual optical coupler 27n of the plurality of optical couplers is configured to direct the respective spectral beam 51n away from a plane of the photonic integrated circuit 210. The optical connector device 500 further includes a spectral multiplexer 570 including a plurality of optical elements configured to iteratively combine the plurality of spectral beams 311, 312, 313, 314 into a combined beam 280. The optical device 500 further includes an optical fiber interface 340 configured to direct the combined beam 280 to an optical fiber 350 external to the optical connector device 500.

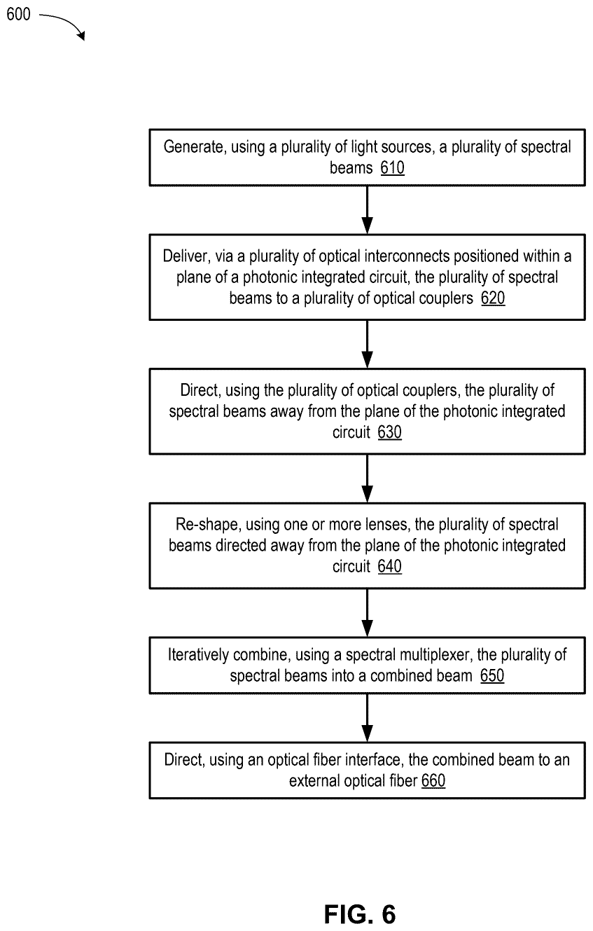

FIG. 6 is a flow diagram of an example method 600 of using an optical transceiver with a vertically integrated wavelength-division optical device for fiber-optic communications, according to at least one embodiment. In some embodiments, operations of method 600 may be performed using systems disclosed in conjunction with FIGS. 2-4. At block 610, method 600 may include generating, using a plurality of light sources (e.g., light sources 201-203, with reference to FIG. 2A), a plurality of spectral beams. An individual spectral beam of the plurality of spectral beams may be generated by a respective light source of the plurality of light sources.

At block 620, method 600 may continue with delivering, via a plurality of optical interconnects positioned within a plane of a photonic integrated circuit, the plurality of spectral beams to a plurality of optical couplers (e.g., optical couplers 271-274, with reference to FIG. 2A, FIGS. 3-4).

At block 630, method 600 may continue with directing, using the plurality of optical couplers, the plurality of spectral beams away from the plane of the photonic integrated circuit (e.g., as illustrated in FIG. 3A). An individual optical coupler (e.g., optical coupler 27n) of the plurality of optical couplers may be directing a respective spectral beam (e.g., spectral beam 31n) of the plurality of spectral beams.

At block 640, may include re-shaping, using one or more lenses (e.g., lenses 321-324, with reference to FIG. 3A) the plurality of spectral beams directed away from the plane of the photonic integrated circuit.

At block 650, method 600 may continue with iteratively combining, using a spectral multiplexer (e.g., WDM block 270), the plurality of spectral beams into a combined beam (e.g., combined beam 280, with reference to FIG. 3A).

At block 660, method 600 may include directing, using an optical fiber interface (e.g., lens 340), the combined beam to an external optical fiber (e.g., optical fiber 350).

### Example Data Center Environment

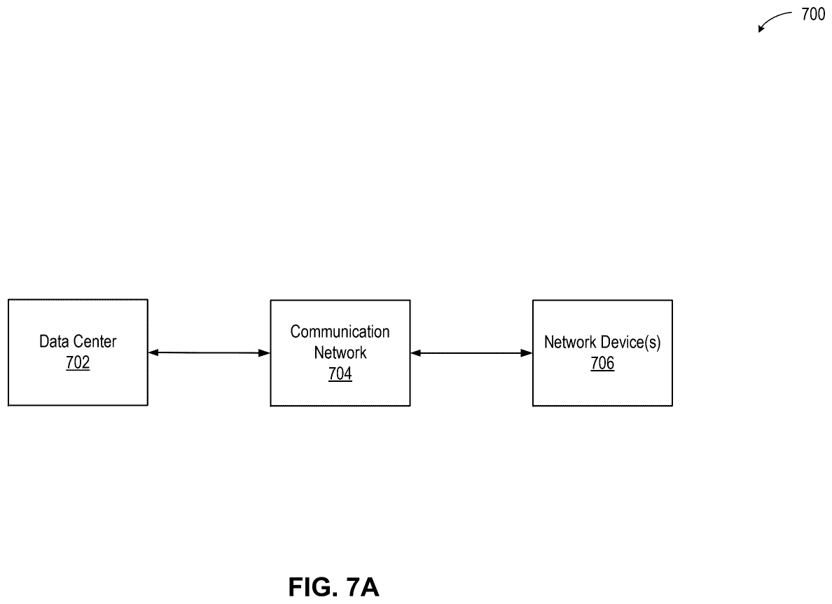

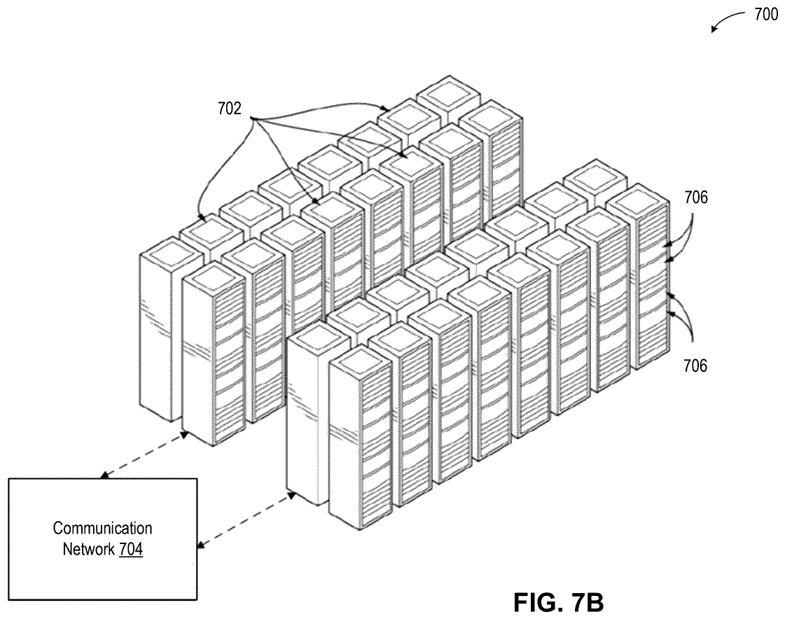

As described above, datacenters, high performance computing clusters, and/or the like are often formed of various computing components or networked devices, and communication networks formed of electrical and/or optical devices may be used to enable communication between the networked devices forming these implementations. With reference to FIGS. 7A-7B, for example, a network architecture 700 may include a datacenter 702, a communication network 704, and network device(s) 706. The network architecture 700 may illustrate a general computing architecture within which more specific systems and/or subsystems may function. Although described hereinafter with reference to a network architecture 700 and/or datacenter 702 within which the embodiments of the present disclosure may be implemented, the present disclosure contemplates that the vertically integrated optical transceivers and techniques described herein may be applicable to any communication implementation without limitation.

For example, the datacenter 702 may be a centralized facility designed to house computing resources and related components. The datacenter 702 may operate to support the infrastructure required for advanced computational tasks, for efficient, secure, and reliable operations. The datacenter 702 may include the building and structural components, including power supplies, cooling systems, fire suppression systems, and physical security measures that are configured to maintain optimal operating conditions and/or protect the equipment from environmental hazards and unauthorized access. An example datacenter 702 may include high-performance servers or compute nodes, often arranged in racks, such as those illustrated in FIG. 7B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The datacenter 702 may include high-speed network equipment, such as network switches, routers, firewalls, and/or the like to facilitate fast and secure data transmission within the datacenter 702 (e.g., between the servers or compute nodes) and between external networks. The datacenter 702 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 702 may support high-performance computing tasks. Examples of various network topologies may include hierarchical networking topologies such as the fat tree topology, Slim Fly topology, Dragonfly topology, and/or the like.

The communication network 704 may communicably couple the datacenter 702 with network device(s) 706 and other external devices for data exchange and connectivity. Examples of the communication network 704 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 704 to incorporate multiple network types and configurations may allow the datacenter 702 to adapt to diverse application needs, from general data communication to specialized HPC tasks. As described herein, the communication network 704 may leverage various optical components to establish communication links (e.g., communicably couple) between components in the architecture 700. As such, the communication network 704 may include various optical devices, transceivers, modules, and/or the like that are configured to generate optical signals (e.g., provide optical transmitter functionality) and/or receive optical signals (e.g., provide optical receiver functionality).

The network device(s) 706 may include a variety of computing devices capable of transmitting and receiving signals over the communication network 704. The network device(s) 706 may range from personal computing devices to complex server configurations. Examples include Personal Computers (PCs), laptops, tablets, smartphones, and servers. The network device(s) 706 may facilitate user interactions with the datacenter 702, allowing for data input, retrieval, and processing from remote locations. In addition to individual computing devices, the network device(s) 706 may also include collections of servers or additional datacenters. For instance, these could be other datacenters similar to or the same as datacenter 702. Such an interconnection may allow for the formation of a distributed computing environment for improved redundancy, load balancing, and disaster recovery capabilities. By linking multiple datacenters, the network architecture 700 may leverage geographically dispersed resources, optimizing performance and ensuring high availability.

As described herein, the datacenter 702 and/or the network device(s) 706 may include storage devices and processing circuitry for executing computing tasks, such as controlling the flow of data internally and over the communication network 704. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the datacenter 702 and network device(s) 706 may include one or more communication interfaces for facilitating wired and/or wireless communication between one another and other unillustrated elements of the network architecture 700. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 700.

Furthermore, the present disclosure contemplates that the network architecture 700 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 700 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 700.

In high-capacity datacenter networks, such as those illustrated in FIGS. 7A-7B, the communication network 704 may leverage optical transceivers that transmit and receive optical signals over optical fibers or other optical communication mediums in order to establish connection between devices in the architecture 700.

In at least one example embodiment, the datacenter 702 corresponds to a collection of network devices, such as network switches (e.g., Ethernet switches) connected with a collection of servers or compute nodes. The datacenter 702 may adhere to a networking topology (e.g., a hierarchal networking topology), such as a fat tree topology, a Slim Fly topology, a Dragonfly topology, and/or the like. The datacenter 702 routes traffic amongst the network switches and servers therein, and at least one layer of the topology in the datacenter 702 is coupled to the communication network 704 to allow networking traffic to flow between the datacenter 702 and the network device(s) 706.

The communication network 704 may communicably couple the datacenter 702 with network device(s) 706 and other external devices for data exchange and connectivity. Examples of the communication network 704 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like.

Each type of network offers specific advantages tailored to different operational requirements. For instance, an IP network or Ethernet network may provide widespread compatibility and ease of integration, supporting various protocols and applications across the datacenter 702 and the network device(s) 706 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote or mobile devices for increased flexibility and accessibility.

The ability of the communication network 704 to incorporate multiple network types and configurations allows the datacenter 702 to adapt to diverse application needs, from general data communication to specialized HPC tasks. Examples of the communication network 704 that may be used to connect the datacenter 702 and the network device(s) 706 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The network device(s) 706 may include a variety of computing devices capable of sending and receiving signals over the communication network 704. The network device(s) 706 can range from personal computing devices to complex server configurations. Examples include Personal Computers (PCs), laptops, tablets, smartphones, and servers. The network device(s) 706 may facilitate user interactions with the datacenter 702, allowing for data input, retrieval, and processing from remote locations. In addition to individual computing devices, the network device(s) 706 may also include collections of servers or additional datacenters. For instance, these could be other datacenters similar to or the same as datacenter 702. Such an interconnection may allow for the formation of a distributed computing environment for improved redundancy, load balancing, and disaster recovery capabilities. By linking multiple datacenters, the data center environment 700 can leverage geographically dispersed resources, optimizing performance and ensuring high availability.

The one or more network devices 706 may include one or more of Personal Computer (PC), a laptop, a tablet, a smartphone, a server, a collection of servers, and/or any suitable computing device for sending and receiving signals over the communication network 704. In at least one example embodiment, the one or more network devices 706 correspond to another datacenter, similar to or the same as datacenter 702.

As noted above, the datacenter 702 and/or the network device(s) 706 may include storage devices and/or processing circuitry for carrying out computing tasks, for example, tasks associated with controlling the flow of data internally and/or over the communication network 170408. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter 702 and network device(s) 706 may include one or more communication interfaces for facilitating wired and/or wireless communication between one another and other unillustrated elements of the data center environment 700. These communication interfaces may include a variety of technologies, including but not limited to Ethernet ports, fiber optic connections, Wi-Fi® transceivers, Bluetooth® modules, and cellular communication modules for integration and interoperability among the various components within the data center environment 700. Furthermore, it should be understood that the data center environment 700 may include additional components and functionalities within the scope of the present disclosure. These components may comprise, without limitation, additional processing units, specialized accelerators (such as Tensor Processing Units or TPUs), enhanced security modules, and redundant power supplies. The inclusion of these elements is intended to ensure that the data center environment 700 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the data center environment 700.

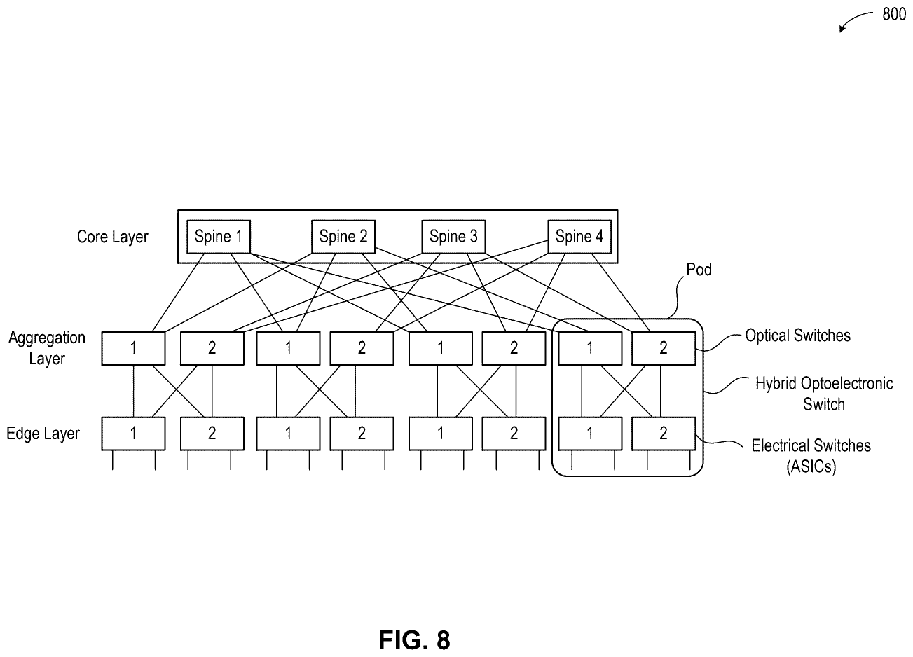

FIG. 8 illustrates a fat tree topology 800 for a datacenter, according to at least one embodiment. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure. In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

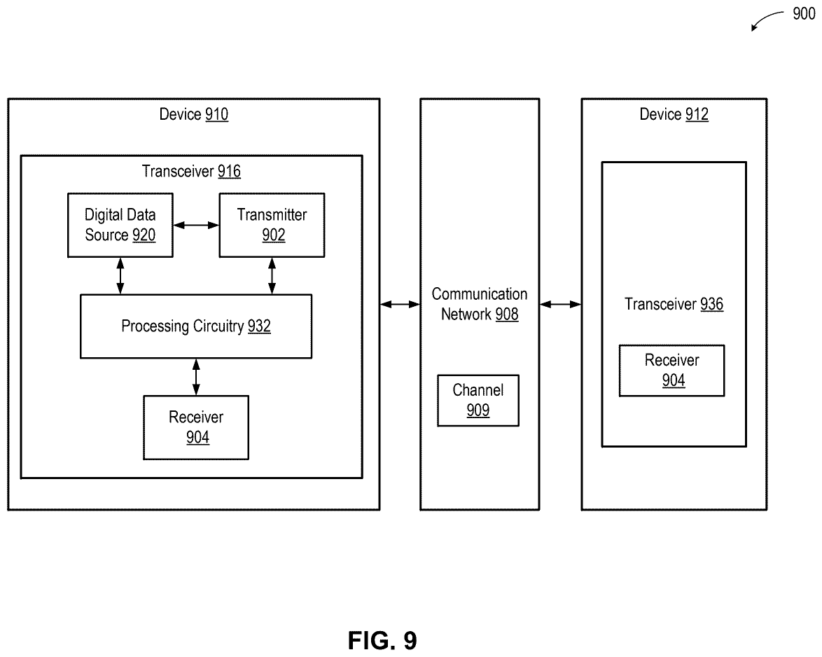

FIG. 9 illustrates an example network architecture 900 capable of deploying vertically integrated wavelength-division optical technology, according to at least one embodiment. Example network architecture 900 includes a device 910 in communication with a device 912 over a communication network 909. The device 910 includes a transceiver 916 for sending and receiving signals, for example, data signals. The data signals may be digital or optical signals modulated with data or other suitable signals for carrying data. The transceiver 916 may include a digital data source 920, a transmitter 902, a receiver 904, and processing circuitry 932 that controls the transceiver 916. The digital data source 920 may include suitable hardware and/or software for outputting data in a digital format (e.g., in binary code and/or thermometer code). The digital data output by the digital data source 920 may be retrieved from memory (not illustrated) or generated according to input (e.g., user input). The transmitter 902 includes suitable software and/or hardware for receiving digital data from the digital data source 920 and outputting data signals according to the digital data for transmission over the communication network 908 to a receiver 904 of device 912. Transmitter 902 an/or receiver 904 may deploy some, any, or all systems and/or devices disclosed above in relation to FIGS. 2-5. The receiver 904 of device 910 and/or device 912 may include suitable hardware and/or software for receiving signals, such as data signals from the communication network 908. For example, the receiver 904 may include components for receiving optical signals. The processing circuitry 932 may comprise software, hardware, or a combination thereof. For example, the processing circuitry 932 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 932 may comprise hardware, such as an application-specific integrated circuit (ASIC). Other non-limiting examples of the processing circuitry 932 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry 932 may be provided on a Printed Circuit Board (PCB) or collection of PCBs. It should be appreciated that any appropriate type of electrical component or collection of electrical components may be suitable for inclusion in the processing circuitry 932. The processing circuitry 932 may send and/or receive signals to and/or from other elements of the transceiver 916 to control the overall operation of the transceiver 916. The transceiver 916 or selected elements of the transceiver 916 may take the form of a pluggable card or controller for the device 910. For example, the transceiver 916 or selected elements of the transceiver 916 may be implemented on a network interface card (NIC).

The device 912 may include a transceiver 936 for sending and receiving signals, for example, data signals over a channel 909 of the communication network 908. The same or similar structure of the transceiver 916 may be applied to transceiver 936, and thus, the structure of transceiver 936 is not described separately. Although not explicitly shown, devices 910 and 912 and the transceivers 916 and 920 may include other processing devices, storage devices, and/or communication interfaces generally associated with computing tasks, such as sending and receiving data

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An optical connector device comprising:
a photonic integrated circuit comprising:
a plurality of optical interconnects, an individual optical interconnect of the plurality of optical interconnects configured to support propagation of a respective spectral beam of a plurality of spectral beams, and
a plurality of optical couplers, an individual optical coupler of the plurality of optical couplers configured to direct the respective spectral beam away from a plane of the photonic integrated circuit;
a spectral multiplexer comprising a plurality of optical elements configured to iteratively combine the plurality of spectral beams into a combined beam; and
an optical fiber interface configured to direct the combined beam to an optical fiber external to the optical connector device.

2. The optical connector device of claim 1, further comprising:
a plurality of light sources, an individual light source of the plurality of light sources configured to generate a corresponding spectral beam of the plurality of spectral beams; wherein the plurality of optical interconnects comprises at least one of:
one or more waveguides, or
one or more optical fibers.

3. The optical connector device of claim 1, wherein the plurality of optical couplers comprises at least one of:
a plurality of diffraction gratings,
a plurality of prisms, or
a plurality of mirrors.

4. The optical connector device of claim 1, wherein the plurality of optical elements comprises:
a plurality of optical filters, wherein an individual optical filter of the plurality of optical filters is configured to:
reflect at least a first subset of the plurality of spectral beams, and
transmit at least a second subset of the plurality of spectral beams.

5. The optical connector device of claim 4, wherein each subsequent optical filter of the plurality of optical filters reflects more spectral beams of the plurality of spectral beams than a subsequent optical filter of the plurality of optical filters.

6. The optical connector device of claim 1, wherein the plurality of optical elements comprises:
a first reflecting region configured to reflect one or more spectral beams of the plurality of spectral beams.

7. The optical connector device of claim 6, wherein each spectral beam of the plurality of spectral beams makes a first angle, which is less than 10 degrees with a normal direction to the photonic integrated circuit, and wherein the first reflecting region makes a second angle, which is more than 5 degrees, with the plane of the photonic integrated circuit.

8. The optical connector device of claim 6, wherein each spectral beam of the plurality of spectral beams makes a first angle, which is more than 5 degrees, with a normal direction to the photonic integrated circuit, and wherein the first reflecting region makes a second angle, which is less than 5 degrees, with the plane of the photonic integrated circuit.

9. The optical connector device of claim 6, wherein each spectral beam of the plurality of spectral beams makes a first angle, which is more than 5 degrees with a normal direction to the photonic integrated circuit, and wherein the first reflecting region makes a second angle, which is more than 5 degrees, with the plane of the photonic integrated circuit.

10. The optical connector device of claim 7, wherein the plurality of optical elements further comprises:
a second reflecting region configured to direct the combined beam towards the optical fiber interface, wherein the second reflecting region makes an angle that is at least 5 degrees to the first reflecting region.

11. The optical connector device of claim 1, wherein the plurality of optical elements comprises:
one or more lenses configured to re-shape the plurality of spectral beams directed away from the plane of the photonic integrated circuit.

12. The optical connector device of claim 11, wherein the one or more lenses are configured to re-shape the plurality of spectral beams by collimating the plurality of spectral beams.

13. The optical connector device of claim 1, wherein the optical fiber interface comprises at least one of:
a focusing lens, or
a curved optical fiber tip.

14. The optical connector device of claim 1, wherein one or more surfaces of the spectral multiplexer are coated with an anti-reflective coating.

15. The optical connector device of claim 1, wherein the plurality of optical couplers is arranged in one or more linear arrays positioned along a direction of the combined beam.

16. The optical connector device of claim 15, wherein the plurality of optical couplers comprises at least four linear arrays, each of the linear arrays having at least ten optical couplers.

17. A wavelength-division multiplexing device comprising:
a plurality of optical elements arranged in one or more linear arrays and configured to receive a plurality of spectral beams, wherein an individual optical element of the plurality of optical elements is configured to:
reflect one or more spectral beams of the plurality of spectral beams, and
transmit one or more other spectral beams of the plurality of spectral beams;
a first reflecting surface configured to reflect the plurality of spectral beams towards the plurality of optical elements;
a second reflecting surface configured to reflect an output beam towards an output optical interface, the output beam formed by iterative reflections of the plurality of spectral beams from the first reflecting surface and at least some of the plurality of optical elements, and wherein the output optical interface is configured to optically couple to an external optical fiber; and
one or more mechanical couplers configured to affix the wavelength-division multiplexing device to an optical chip device.

18. The wavelength-division multiplexing device of claim 17, wherein the one or more mechanical couplers are integrated in a housing enclosing the plurality of optical elements, the wavelength-division multiplexing device further comprising:
the optical chip device supporting a plurality of optical couplers configured to direct the plurality of spectral beams towards the plurality of optical elements at an angle with a plane of the optical chip device that exceeds 70 degrees.

19. The wavelength-division multiplexing device of claim 17, wherein the second reflecting surface makes an angle that is at least 5 degrees to the first reflecting surface.

20. An optical transceiver comprising:
a photonic integrated circuit comprising:
one or more optical modulators to encode a transmitted electronic signal in a plurality of spectral beams;
a plurality of optical couplers, an individual optical coupler of the plurality of optical couplers configured to direct a respective spectral beam away from a plane of the photonic integrated circuit;
a plurality of optical interconnects, an individual optical interconnect of the plurality of optical interconnects configured to deliver the respective spectral beam of the plurality of spectral beams to the individual optical coupler; and
a wavelength-division multiplexing block comprising a plurality of optical elements configured to:
iteratively combine the plurality of spectral beams into a combined beam; and
an optical fiber interface configured to direct the combined beam to an external optical fiber.

21. The optical transceiver of claim 20, further comprising:
a plurality of photodetectors to convert a plurality of received spectral beams into a received electronic signal, wherein the plurality of received spectral beams is obtained by demultiplexing, using the wavelength-division multiplexing block, of a beam delivered by the external optical fiber via the optical fiber interface.

22. A wavelength-division multiplexing block configured to:
receive multiple spectral beams directed away from a plane of a photonic integrated circuit at an angle 70 degrees or more to the plane;
combine the multiple spectral beams into a combined beam; and
output the combined beam to an external optical fiber.

23. A method comprising:
generating, using a plurality of light sources, a plurality of spectral beams, an individual spectral beam of the plurality of spectral beams generated by a respective light source of the plurality of light sources;
delivering, via a plurality of optical interconnects positioned within a plane of a photonic integrated circuit, the plurality of spectral beams to a plurality of optical couplers;
directing, using the plurality of optical couplers, the plurality of spectral beams away from the plane of the photonic integrated circuit, an individual optical coupler of the plurality of optical couplers directing a respective spectral beam of the plurality of spectral beams;
re-shaping, using one or more lenses, the plurality of spectral beams directed away from the plane of the photonic integrated circuit;
iteratively combining, using a spectral multiplexer, the plurality of spectral beams into a combined beam; and
directing, using an optical fiber interface, the combined beam to an external optical fiber.
